(19) United States
(12) Patent Application Publication
(10) Pub. No.: US 2012/0311006 A1
(43) Pub. Date: Dec. 6, 2012

(54) METHOD FOR IMPROVING COMPUTATION SPEED OF CROSS-COVARIANCE FUNCTION AND AUTOCOVARIANCE FUNCTION FOR COMPUTER HARDWARE

(76) Inventors: Juei-Chao Chen, Taoyuan County (TW); Tien-Lung Sun, Taoyuan County (TW); Kuo-Hung Lo, Taoyuan County (TW)

(21) Appl. No.: 13/118,588

(22) Filed: May 31, 2011

(51) Int. Cl. G06F 17/15

(52) U.S. Cl. 708/426

(57) ABSTRACT

A computation method based on successive difference is disclosed herein. The computation method performs computation by weighted coefficient provided by the present embodiment, and calculates ACF and CCF directly without computation on means beforehand. Further decomposing the weighted coefficient, a method being recursive and capable of updating immediately is obtained. The computation accuracy of the present embodiment is compared to StRD dataset and PROC ARIMA of SAS ver. 9.0; the result shows that the present embodiment is of a high computation accuracy and further solves problems of prior art that ACF and CCF computation requires confirmation on data number beforehand, and unable to perform updating.

### BACKGROUND OF THE INVENTION

1. Field of the Invention

The present embodiment relates to a statistical analysis and time series application method for computation of cross-covariance function and autocovariance function, wherein related computation procedure can be applied to data analysis as described below:

A. computation of autocovariance function and autocorrelation function;

B. computation of partial autocorrelation function;

C. computation of cross-covariance function and cross-correlation function;

D. computation of autocovariance matrix and autocorrelation matrix; and

E. computation related to time series analysis in the field of financial analysis and industrial engineering.

2. Brief Description of the Related Art

In order to effectively and briefly describing prior art of the present embodiment (hereinafter the prior art), the prior art is itemized into five descriptions listed below.

1. Data can be one of two categories: cross sectional and time series.

According to Anderson et al. (2006), collected data can be of two categories: cross sectional and time series, wherein cross sectional data is data collected at the same time (or approximately the same time,) and time series data is data collected with time. The two kinds of data are further described hereinafter.

(i) Cross sectional data:

Data collected at a specific period of time. First data collected is x₁, second data collected is x₂, and the rest can be defined in the same manner, wherein the n^{th} data collected is xₙ. The above-mentioned data can be shown as a set as: {x₁, x₂, . . . , xₙ}, and as vector as:

x_{1×n}^{T}=[x₁ x₂ . . . xₙ]. (1)

(ii) Time series data:

Data collected in a continuous period of time. First data collected is x₁, second data collected is x₂, the i^{th} data collected is xᵢ, the i+1^{th} data collected is xᵢ₊₁, and the n^{th} collected is xₙ; the rest can be defined in the same manner, whereas the above-mentioned data can be shown as a set as: {x₁, x₂, . . . , xᵢ, xᵢ₊₁, . . . , xₙ, . . . } where the first n are the data collected in the continuous period of time and as vector as:

x_{1×n}^{T}=[x₁ x₂ . . . xₙ]. (2)

The vectors of equation (1) and (2) showing the foregoing data x₁˜xₙ are of a same representation type; however, their data attributes are different. Data of equation (1) has no sequential relationship, whereas data of equation (2) are collected sequentially with time.

2. Cross sectional and time series data calculations related to sums of squares of deviation from mean, and definition of autocovariance function.

The mean of the data (x₁˜xₙ) is obtained by adding up the data (1˜n) and then divide it by n; shown as:

$${\overline{x}}_{n} = \frac{1}{n} {\sum }_{i = 1}^{n} {x}_{i} . \qquad ( 3 )$$

The equation (3) is applicable to calculations of both (1) and (2).

With regards to the different data types, computation of sums of squares of deviation from mean for the data (x₁˜xₙ) is very important in data analysis. Descriptions of the two categories of data: cross sectional and time series data are listed as below.

(i) Cross sectional data:

For cross sectional data (x₁˜xₙ) as equation (1), square of deviation, or square of deviation from mean is the square of each data value (x₁, x₂, . . . , xₙ) minus the mean x̅ₙ, shown as: (x₁− x̅ₙ)². And add up the square of deviation of each data, the sums of square of deviation from mean, or Corrected Sums of Squares (hereinafter CSS) is obtained, shown as below:

$${CSS}_{n} = {\sum }_{i = 1}^{n} {( {x}_{i} - {\overline{x}}_{n} )}^{2} . \qquad ( 4 )$$

Wherein, x̅ₙ is obtained from equation (3).

(ii) Time series data:

For time series data (x₁˜xₙ) as equation (2), the vector representation of sequence of the 1^{st} data to (n−k)^{th} data is as below: [x₁ x₂ . . . xₙ₋ₖ]_{1×(n-k)}, (5)

and the vector representation of sequence of the (k+1)^{th} data to n^{th} data is as below:

[xₖ₊₁ xₖ₊₂ . . . xₙ]_{1×(n-k)}. (6)

Each element of the equation (5) and (6) then subtract the mean x̅ₙ defined in equation (3), wherein the vector representation is as below:

[(x₁− x̅ₙ) (x₂− x̅ₙ) . . . (x_{n k}− x̅ₙ)]_{1×(n-k)}, (7)

and

[(xₖ₊₁− x̅ₙ) (xₖ₊₂− x̅ₙ) . . . (xₙ− x̅ₙ)]_{1×(n-k)}. (8)

Multiplying the first element of equation (7) (x₁− x̅ₙ), with the first element of equation (8), (xₖ₊₁− x̅ₙ); multiplying the second element of equation (7), (x₂− x̅ₙ), with the second element of equation (8), (xₖ₊₂− x̅ₙ); the rest can be done in the same manner to the (n−k)^{th} element. Adding up all the foregoing results, and divide the sum by n, an Autocovariance Function at lag k is thereby obtained, shown as C_{XX}(A), and equation is as below:

$${C}_{XX} ( k ) = \frac{1}{n} {\sum }_{i = 1}^{n - k} ( {x}_{i} - {\overline{x}}_{n} ) ( {x}_{i + k} - {\overline{x}}_{n} ) \qquad ( 9 )$$

Wherein, k<n/2, and x̅ₙ is obtained from equation (3).

Wherein, equation (9) is defined according to definition of Box et al. (2008).

3. Sum of the product of the deviations of two variables, X and Y, from their respective means computation goes from sums of square of deviation from mean that is single variable to two variable data; Descriptions of the two categories of data: cross sectional and time series data are listed as below.

(i) Cross sectional data:

For the two variables data 1˜n, the first data is (x₁, y₁), the second data is (x₂, y₂), the i^{th} data is (xᵢ, yᵢ), and the rest can be defined in the same manner, wherein the n^{th} data is (xₙ, yₙ). Wherein, x̅ₙ and y̅ₙ are subtracted from (xᵢ, yᵢ) respectively, and then multiply the difference and get the total, which is called Corrected Sums of Products, CSP; shown as:

$${CSP}_{n} = {\sum }_{i = 1}^{n} ( {x}_{i} - {\overline{x}}_{n} ) ( {y}_{i} - {\overline{y}}_{n} ) . \qquad ( 10 )$$

Wherein, covariance of X and Y is CSPₙ divided by n−1, shown as: cov(X,Y). The equation thereof is as below:

$$cov ( X , Y ) = \frac{{CSP}_{n}}{n - 1}$$

(ii) Time series data:

For the two variable time series data, the first variable is x, the second variable is y. The first data collected is (x₁, y₁), the second data collected is (x₂, y₂), the i^{th} data collected is (xᵢ, yᵢ), and the n^{th} data collected is (xₙ, yₙ); the rest can be defined in the same manner, wherein the set thereof is shown as:

{(x₁,y₁), (x₂,y₂), . . . , (xᵢ,yᵢ), (xᵢ₊₁,yᵢ₊₁), . . . , (xₙ,yₙ), . . . }

With regards to the variable x, the vector of the first data to the (n−k)^{th} data is shown as:

[x₁ x₂ . . . xₙ₋ₖ]_{1×(n-k)}, (11)

with regards to the variable y, the vector of the (k+1)^{th} data to the n^{th} data is shown as:

[yₖ₊₁ yₖ₊₂ . . . yₙ]_{1×(n-k)}. (12)

The mean x̅ₙ is respectively subtracted from each data in equation (11): x₁, x₂, . . . , xₙ₋ₖ wherein the vector thereof is shown as:

[(x₁− x̅ₙ) (x₂− x̅ₙ) . . . (xₙ₋ₖ− x̅ₙ)]_{1×(n-k)}, (13)

The mean y̅ₙ is respectively subtracted from each data in equation (12): yₖ₊₁, yₖ₊₂, . . . , yₙ, wherein the vector thereof is shown as:

[(yₖ₊₁− y̅ₙ) (yₖ₋₂− y̅ₙ) . . . (yₙ− y̅ₙ)]_{1×(n-k)}, (14)

Multiply the first element of equation (13), (x₁− x̅ₙ), with the first element of equation (14), (x₂− x̅ₙ); multiply the second element of equation (13), (x₂− x̅ₙ), with the second element of equation (14), (x₂− x̅ₙ); the rest can be done in the same manner to the (n−k)^{th} data. The sum of the foregoing results divided by n is the Cross-covariance Function at lag k, shown as C_{XY}(k), and the equation is as below:

$${C}_{XY} ( k ) = \frac{1}{n} {\sum }_{i = 1}^{n - k} ( {x}_{i} - {\overline{x}}_{n} ) ( {y}_{i + k} - {\overline{y}}_{n} ) , \qquad ( 15 )$$

Wherein, k<n/2, and x̅ₙ is obtained from equation (3).

Wherein, equation (15) is defined according to definition of Box et al. (2008).

4. The definition of updating

Updating, according to the study of Chan et al. (1979), is when a new data is collected and put into an equation, using the new data to compute a new result and update the result computed before the new data is collected. According to Higham (2004), the updating equation is shown as below:

New_value=old_value+small_correction (16)

The computation module of equation (16) is called updating. Updating helps to save the hardware resource and supports the dynamic data analysis.

5. Problems and applications of Autocorrelation Function and Cross-correlation Function

Many of the computations related to time series data are based on equation (9) and (15), such as Autocorrelation Function, Partial Autocorrelation Function, PACF, Autocovariance matrix or Autocorrelation matrix. Please refer to Box et al. (2008) for related definitions and applications. According to McCullough (1998), computation of PACF on data analysis software is unable to be accurate and effective at the same time. Further, McCullough (1998) also points out that there are two computation methods for ACF and PACF: direct computation method and Newton (1988) method. Further, the study of Keeling and Pavur (2007) focuses on computation accuracy of nine commonly used data analysis software such as EXCEL XP, EXCEL 2003, JMP 5.0, Minitab 14.0, R1.9.1, SAS 9.1, Splus 6.2, SPSS 12.0, Stat 8.1 and StatCrunch 3.0; wherein, the accuracy of the nine commonly used data analysis software is still requiring improvement.

### SUMMARY OF THE INVENTION

The present embodiment is based on the successive difference developed by the applicant, and the weight (wᵢⱼ) proposed by the applicant to perform the computation of ACF and CCF. The computation equations of ACF and CCF are the equation (9) and (15). The equation (9) and (15) multiply by n is the new computation method disclosed by the present embodiment.

An object of the present embodiment is to first develop a method of an equation:

$$\frac{1}{n} {d}_{1 \times n ( k )}^{T} {W}_{n \times n} {e}_{n \times 1}$$

by decomposing the n×n matrix, W_{n×n} wherein the method is recursive and capable of updating. Secondly, combine the foregoing method with the updating computation when there is new data collected thereto. This solves the prior problem of having to compute the mean first when performing computation of ACF and CCF. All the prior methods that require computation of mean beforehand is a two-pass method; all data to be computed needs to be read by hardware twice. However, the method of the present embodiment is a one-pass method wherein the data only has to be read once; this helps saving the hardware storage space and increases computation efficiency. The method disclosed by the present embodiment is thereby capable of solving the prior art's problem of being unable to maintain accuracy while having to perform updating. Another object of the present embodiment is to use the successive difference as a basis in order to perform recursion and update the CCF computation method. ACF is the special case of univariate thereof; for computation of ACF, replace the bivariate of the foregoing method with univariate.

Further, the method of the present embodiment has high computation accuracy; this helps to improve the computation accuracy of software computation of functions related to ACF and CCF.

### DETAILED DESCRIPTION OF THE PREFERRED EMBODIMENTS

The present embodiment provides a computation method for Cross-covariance Function (hereinafter C_{XY}(k)) and Autocovariance Function (hereinafter C_{XX}(k)); wherein the computation method is based on successive difference and a weighted coefficient wᵢⱼ, thereby does not require computation of mean in advance.

(i) Cross-covariance Function

With regards to the Cross-covariance Function, it possesses n data of bivariate, wherein a first data of a first variable is x₁, a second data of the first variable is x₂, and the rest can be defined in the same manner wherein an n^{th} data is xₙ. Define sdx₁=x₁, an i^{th} successive difference of the first variable refers to the amount that an i−1^{th} data value xᵢ₋₁ subtracted from an i^{th}data value xᵢ; equation shown as: sdxᵢ=xᵢ−xᵢ₋₁, wherein i=2,3, . . . , n. A first data of a second variable is y₁, a second data of the second variable is y₂, and the rest can be defined in the same manner wherein an n^{th} data is yₙ. Define sdy₁=y₁, an i^{th} successive difference of the second variable refers to the amount that an i−1^{th} data value yᵢ₋₁ subtracted from an i^{th} data value yᵢ; equation shown as: sdyᵢ=yᵢ−yᵢ₋₁, wherein i=2,3, . . . , n.

Firstly computation of nC_{XY}(A) is shown as:

$$\begin{matrix}{nC}_{XY} ( k ) = \frac{1}{n} {d}_{1 \times n ( k )}^{T} {W}_{n \times n} {e}_{n \times 1} + {A}_{XY} \\ Wherein , & ( 17 ) \\ {W}_{n \times n} = {⌊ {w}_{ij} ⌋}_{n \times n} , \\ {w}_{ij} = ( n + 1 ) ( i + j - 1 ) - ij - \frac{n}{2} ( i + j + \vert i - j \vert ) , \\ i = 1 , 2 , … , n , j = 1 , 2 , … , n . \\ {e}_{n \times 1}^{T} = {[ \begin{matrix}{sdx}_{1} & {sdx}_{2} & … & {sdx}_{n}\end{matrix} ]}_{1 \times n} , & ( 18 ) \\ {d}_{1 \times n ( k )}^{T} = {[ \begin{matrix}\underbrace{0 … 0}_{k items} & {sdx}_{1} & … \vert & {sdx}_{n - k}\end{matrix} ]}_{1 \times n} , \\ Wherein , \\ {d}_{1 \times n ( 0 )}^{T} = {[ \begin{matrix}{sdx}_{1} & {sdx}_{2} & … & {sdx}_{n}\end{matrix} ]}_{1 \times n} , \\ {d}_{1 \times n ( 1 )}^{T} = {[ \begin{matrix}0 & {sdx}_{1} & {sdx}_{2} & … & {sdx}_{n - 1}\end{matrix} ]}_{1 \times n} , \\ {d}_{1 \times n ( 2 )}^{T} = {[ \begin{matrix}\underbrace{0 \; 0}_{2 items} & {sdx}_{1} & … & {sdx}_{n - 2}\end{matrix} ]}_{1 \times n} , \\ … \\ until k < \frac{n}{2} & ( 19 )\end{matrix}$$

Further, A_{XY} can be shown in two forms of equations:

$$\begin{matrix} ( a ) {A}_{XY} = k {\overline{x}}_{n} ( {\overline{y}}_{k} - {\overline{y}}_{n} ) & ( 20 ) \\ ( b ) {A}_{XY} = k ( {x}_{n} - \frac{1}{n} {\sum }_{i = 1}^{n} ( i - 1 ) {sdx}_{i} ) ( ( {y}_{k} - \frac{1}{k} {\sum }_{i = 1}^{k} ( i - 1 ) {sdy}_{i} ) - ( {y}_{n} - \frac{1}{n} {\sum }_{i = 1}^{n} ( i - 1 ) {sdy}_{i} ) ) & ( 21 )\end{matrix}$$

The computation of Cross-covariance Function at lag k is to divide the result from the equation (17) by n. The iterative computation developing process of

$$\frac{1}{n} {d}_{1 \times n ( k )}^{T} {W}_{n \times n} {e}_{n \times 1}$$

and A_{XY} are described hereinafter.

(i) The iterative computation of

$$\frac{1}{n} {d}_{1 \times n ( k )}^{T} {W}_{n \times n} {e}_{n \times 1}$$

In practice, d_{1×n(k)}^{T}W_{n×n}e_{n×1} is the only consideration; divide it by n. In order to further describe elements of W_{n×n} matrix of different orders, redefine elements of i^{th} row and j^{th} column of n×n matrix W_{n×n}, hereinafter wᵢⱼ₍ₙ₎, and shown as:

$${w}_{ij ( n )} = ( n + 1 ) ( i + j - 1 ) - ij - \frac{n}{2} ( i + j + \vert i - j \vert ) , \\ i = 1 , 2 , … , n , j = 1 , 2 , … , n .$$

Decomposition of the matrix W_{n×n} is of two stages.

Stage 1:

Decomposing the matrix W_{n×n} to two matrices, shown as:

$${W}_{n \times n} = [ \begin{matrix}{w}_{11} & {w}_{12} & {w}_{13} & … & {w}_{1 n} \\ {w}_{21} & {w}_{22} & {w}_{23} & … & {w}_{2 n} \\ {w}_{31} & {w}_{32} & {w}_{33} & … & {w}_{3 n} \\ ⋮ & ⋮ & ⋮ & ⋱ & ⋮ \\ {w}_{n 1} & {w}_{n 2} & {w}_{n 3} & … & {w}_{nn}\end{matrix} ] = {[ \begin{matrix}{W}_{( n - 1 ) \times ( n - 1 )} & {0}_{( n - 1 ) \times 1} \\ {0}_{1 \times ( n - 1 )} & 0\end{matrix} ]}_{n \times n} + {G}_{n \times n} , \\ Wherein , \\ {W}_{( n - 1 ) \times ( n - 1 )} = {⌊ {w}_{ij ( n - 1 )} ⌋}_{( n - 1 ) \times ( n - 1 )} , \\ {w}_{ij ( n - 1 )} = n ( i + j - 1 ) - ij - \frac{( n - 1 )}{2} ( i + j + \vert i - j \vert ) , \\ i = 1 , 2 , … , n - 1 , j = 1 , 2 , … , n - 1. \\ {0}_{1 \times ( n - 1 )} = {[ \begin{matrix}0 & 0 & … & 0\end{matrix} ]}_{1 \times ( n - 1 )} , \\ {0}_{( n - 1 ) \times 1} = {[ \begin{matrix}0 \\ 0 \\ ⋮ \\ 0\end{matrix} ]}_{( n - 1 ) \times 1} . \qquad ( 22 )$$

Stage 2

Decomposing the matrix G_{n×n}, shown as:

$${G}_{n \times n} = {[ \begin{matrix}{G}_{( n - 1 ) \times ( n - 1 )} & {M}_{( n - 1 ) \times 1} \\ {M}_{1 \times ( n - 1 )}^{T} & ( n - 1 )\end{matrix} ]}_{n \times n} , \\ Wherein , \\ {G}_{( n - 1 ) \times ( n - 1 )} = {⌊ {g}_{ij} ⌋}_{( n - 1 ) \times ( n - 1 )} \\ {g}_{ij} = \frac{1}{2} ( i + j - \vert i - j \vert - 2 ) , \\ i = 1 , 2 , … , n - 1 , j = 1 , 2 , … , n - 1. \\ {M}_{1 \times ( n - 1 )}^{T} = {[ \begin{matrix}0 & 1 & … & n - 2\end{matrix} ]}_{1 \times ( n - 1 )} . \qquad ( 23 )$$

The first part of the present embodiment substitute the equation (22) and (23) in d_{1×n(k)}^{T}W_{n×n}e_{n×1} to develop an iterative computation by the following two steps:

Step 1 Substituting the equation (22) into d_{1×n(k)}^{T}W_{n×n}e_{n×1}

Define DWEₙ=d_{1×n(k)}^{T}W_{n×n}e_{n×1}, and obtain:

$$\begin{matrix}{DWE}_{n} = {d}_{1 \times n ( k )}^{T} {W}_{n \times n} {e}_{n \times 1} \\ = {d}_{1 \times n ( k )}^{T} ( {[ \begin{matrix}{W}_{( n - 1 ) \times ( n - 1 )} & {0}_{( n - 1 ) \times 1} \\ {0}_{1 \times ( n - 1 )} & 0\end{matrix} ]}_{n \times n} + {G}_{n \times n} ) {e}_{n \times 1} \\ = {{d}_{1 \times n ( k )}^{T} [ \begin{matrix}{W}_{( n - 1 ) \times ( n - 1 )} & {0}_{( n - 1 ) \times 1} \\ {0}_{1 \times ( n - 1 )} & 0\end{matrix} ]}_{n \times n} {e}_{n \times 1} + {d}_{1 \times n ( k )}^{T} {G}_{n \times n} {e}_{n \times 1} \\ = {DWE}_{n - 1} + {d}_{1 \times n ( k )}^{T} {G}_{n \times n} {e}_{n \times 1}\end{matrix} \qquad ( 24 )$$

Step 2 Substituting the equation (23) into a second item on right-hand side of the equation (24) d_{1×n(k)}^{T}G_{n×n}e_{n×1}

According to the equation (19), d_{1×n(k)}^{T}=[0 . . . 0 sdx₁ . . . sdxₙ₋ₖ]_{1×n}, let sdx*ᵢ=0, i=1, 2, . . . , k, sdx*ᵢ₊ₖ=sdxᵢ, i=1, 2, . . . , n−k, then

Define DGEₙ=d_{1×n(k)}^{T}G_{n×n}e_{n×1}, and obtain

$$\begin{matrix}{DGE}_{n} = {d}_{1 \times n ( k )}^{T} {G}_{n \times n} {e}_{n \times 1} \\ = {{d}_{1 \times n ( k )}^{T} [ \begin{matrix}{G}_{( n - 1 ) \times ( n - 1 )} & {M}_{( n - 1 ) \times 1} \\ {M}_{1 \times ( n - 1 )}^{T} & ( n - 1 )\end{matrix} ]}_{n \times n} {e}_{n \times 1} \\ = {[ \begin{matrix}{sdx}_{1}^{*} & … & {sdx}_{n - 1}^{*} \vert & {sdx}_{n}^{*}\end{matrix} ]}_{1 \times n} \\ {{[ \begin{matrix}{G}_{( n - 1 ) \times ( n - 1 )} & {M}_{( n - 1 ) \times 1} \\ {M}_{1 \times ( n - 1 )}^{T} & ( n - 1 )\end{matrix} ]}_{n \times n} [ \begin{matrix}{sdy}_{1} \\ ⋮ \\ {sdy}_{n - 1} \\ {sdy}_{n}\end{matrix} ]}_{n \times 1} \\ = {d}_{1 \times ( n - 1 ) ( k )}^{T} {G}_{( n - 1 ) \times ( n - 1 )} {e}_{( n - 1 ) \times 1} + {d}_{1 \times ( n - 1 ) ( k )}^{T} {M}_{( n - 1 ) \times 1} {sdy}_{n} + \\ {sdx}_{n}^{*} {M}_{1 \times ( n - 1 )}^{T} {e}_{( n - 1 ) \times 1} + ( n - 1 ) {sdx}_{n}^{*} {sdy}_{n} \\ = {DGE}_{n - 1} + ( {\sum }_{i = 1}^{n - 1} ( i - 1 ) {sdx}_{i}^{*} ) {sdy}_{n} + ( {\sum }_{i = 1}^{n - 1} ( i - 1 ) {sdy}_{i} ) {sdx}_{n}^{*} + \\ ( n - 1 ) {sdx}_{n}^{*} {sdy}_{n}\end{matrix} \qquad ( 25 )$$

Substituting the equation (25) into equation (24) and obtain:

$$\begin{matrix}{DWE}_{n} = {DWE}_{n - 1} + {DGE}_{n} \\ = {DWE}_{n - 1} + {DGE}_{n - 1} + ( {\sum }_{i = 1}^{n - 1} ( i - 1 ) {sdx}_{i}^{*} ) {sdy}_{n} + \\ ( {\sum }_{i = 1}^{n - 1} ( i - 1 ) {sdy}_{i} ) {sdx}_{n}^{*} + ( n - 1 ) {sdx}_{n}^{*} {sdy}_{n}\end{matrix} \qquad ( 26 )$$

(ii) The iterative computation of A_{XY}

With regards to A_{XY}, the present embodiment uses successive difference computation method, as shown in equation (21),

$$k ( {x}_{n} - \frac{1}{n} {\sum }_{i = 1}^{n} ( i - 1 ) {sdx}_{i} ) ( ( {y}_{k} - \frac{1}{k} {\sum }_{i = 1}^{k} ( i - 1 ) {sdy}_{i} ) - ( {y}_{n} - \frac{1}{n} {\sum }_{i = 1}^{n} ( i - 1 ) {sdy}_{i} ) ) .$$

Wherein, the iterative computation thereof is described with

$$( {x}_{n} - \frac{1}{n} {\sum }_{i = 1}^{n} ( i - 1 ) {sdx}_{i} )$$

as shown below:

$$\begin{matrix}Define {WSUM\_SDX}_{n} = {x}_{n} - \frac{1}{n} {\sum }_{i = 1}^{n} ( i - 1 ) {sdx}_{i} , and obtain & \\ {WSUM\_SDX}_{n} = {WSUM\_SDX}_{n - 1} + {\sum }_{i = 1}^{n} {sdx}_{i} \\ Since ( {y}_{k} - \frac{1}{k} {\sum }_{i = 1}^{k} ( i - 1 ) {sdy}_{i} ) of \\ k ( {x}_{n} - \frac{1}{n} {\sum }_{i = 1}^{n} ( i - 1 ) {sdx}_{i} ) ( ( {y}_{k} - \frac{1}{k} {\sum }_{i = 1}^{k} ( i - 1 ) {sdy}_{i} ) - ( {y}_{n} - \frac{1}{n} {\sum }_{i = 1}^{n} ( i - 1 ) {sdy}_{i} ) ) and ( {y}_{k} - \frac{1}{k} {\sum }_{i = 1}^{k} ( i - 1 ) {sdy}_{i} ) and ( {y}_{n} - \frac{1}{n} {\sum }_{i = 1}^{n} ( i - 1 ) {sdy}_{i} ) ( {x}_{n} - \frac{1}{n} {\sum }_{i = 1}^{n} ( i - 1 ) {sdx}_{i} ) & ( 27 )\end{matrix}$$

are of the same computation method, the present embodiment does not further describe the details hereby; according to result of equation (27), the iterative computation for A_{XY} can be performed.

As the foregoing, the result of equation (26) and (27) is the iterative computation method for nC_{XY}(k), wherein the method can be written as steps that can be implemented on hardware of:

Step 1: defining hardware implementing variable Defining computation variables; all variable are with an initial value of 0, wherein:

defining k value;

defining n_cxy_k as nC_{XY}(k);

defining dwe as DWEₙ of equation (26);

defining dge as DGEₙ of equation (26);

defining corrected_term as equation (21).

The successive difference value of the first variable is sdx[i]. Further, sdx is sdxᵢ* of the equation (26), wherein i=1 at the first implementation, i=2 at the second implementation, and the rest can be defined in the same manner.

The successive difference value of the second variable sdy is sdyᵢ of the equation (26).

The successive difference iteration sum of the first variable is isum_sdx, shown as

$$( {\sum }_{i = 1}^{n - 1} ( i - 1 ) {sdx}_{i}^{*} )$$

in equation (26).

The successive difference iteration sum of the second variable is isum_sdy, shown as

$$( {\sum }_{i = 1}^{n - 1} ( i - 1 ) {sdy}_{i} )$$

in equation (26).

$$define n\_sum \_sdx as ( {\sum }_{i = 1}^{n} ( n - i + 1 ) {sdx}_{i} ) ;$$

$$define k\_sum \_sdy as ( {\sum }_{i = 1}^{k} ( k - i + 1 ) {sdy}_{i} ) ;$$

$$define n\_sum \_sdy as ( {\sum }_{i = 1}^{n} ( n - i + 1 ) {sdy}_{i} ) ;$$

$$define sum\_sdx as {\sum }_{i = 1}^{n} {sdx}_{i} ;$$

$$define sum\_sdy as {\sum }_{i = 1}^{n} {sdy}_{i} .$$

Step 2: reading the i^{th} data and computation of the successive difference value of the two variables, sdx and sdy
sdx adding sum_sdx, and saved in sum_sdx
sum_sdx adding n_sum_sdx, and saved in n_sum_sdx
sdy adding sum_sdy, and saved in sum_sdy
sum_sdy adding n_sum_sdy, and saved in n_sum_sdy

Step 3: determining conditions
(i) if i≦k,
   let sdx=0,
      k_sum_sdy=n_sum_sdy
(ii) if i>k, then sdx=sdx[i−k]

Step 4:
(i) Multiplying (i−1) with sdx, and then with sdy;
(ii) Multiplying isum_sdx with sdy, and multiplying isum_sdy with sdx;
Adding sum of all values of (i) and (ii) to dge, and then saving to dge thereof.

Step 5: Adding dge of the step 4 to wde and then saving the result to wde

Step 6: Performing recursive computation for isum_sdx and isum_sdy
(i) Multiplying (i−1) with sdx, and adding isum_sdx thereto, and then save the result to isum_sdx
(ii) Multiplying (i−1) with sdy, and adding isum_sdy thereto, and then save the result to isum_sdy

Step 7:
(i) Dividing k_sum_sdy by k
(ii) Dividing n_sum_sdy by n
(iii) The result of (i) subtracting the result of (ii), and then multiplying by

$$\frac{k}{n} ;$$

saving the foregoing result to corrected term

Step 8: dividing wde by i, adding the corrected_term thereto, and then saving to n_cxy_k; when the i+1^{th}data is added, go back to step 2.

The foregoing steps can be written in algorithm that is capable of implementing on hardware:

```
n_cxy_k:=0
dwe:=0
dge:=0
corrected_term:=0
isum_sdx:=0
isum_sdy:=0
n_{—} sum_sdx:=0
k_{—} sum_sdx:=0
n_{—} sum_sdy:=0
sum_sdx:=0
sum_sdy:=0
for i := 1 i+1
  input Xᵢ, Yᵢ
  sdx[i]:=Xᵢ−Xᵢ₋₁
  sdy:=Yᵢ−Yᵢ₋₁
    sum_sdx := sum_sdx + sdx[i]
    sum_sdy := sum_sdy + sdy
    n_{—} sum_sdx := n_{—} sum_sdx + sum_sdx
    n_{—} sum_sdy := n_{—} sum_sdy + sum_sdy
    if i≦k then
      sdx := 0,
      k_{—} sum_sdy := n_{—} sum_sdy
    else sdx := sdx[i−k]
      dge := dge + isum_sdx*sdy + isum_sdy*sdx +
(i−1)*sdx*sdy
      dwe := dwe + dge
      isum_sdx := isum_sdx + (i−1)* sdx
      isum_sdy := isum_sdy + (i−1)* sdy
  n_cxy_k :=dwe/i + (k/n)*( n_{—} sum_sdx)*( k_{—} sum_sdy/k −
n_{—} sum_sdy/n)
```

(ii) Autocovariance Function

When equation (17) is of univariate, the Autocovariance Function at lag k thereof is shown as:

$${nC}_{XX} ( k ) = \frac{1}{n} {d}_{1 \times n ( k )}^{T} {W}_{n \times n} {d}_{n \times 1} + {A}_{XX} \qquad ( 28 )$$

Wherein, the coefficient of W_{n×n} is as equation (18), and d_{1×n(k)}^{T} as equation (19):

d_{1×n}^{T}=d_{1×n(0)}^{T}=[sdx₁ sdx₂ . . . sdxₙ]_{1×n} (29)

Further, A_{XX} can be shown as:

$$\begin{matrix}( a ) & \\ {A}_{XX} = k {\overline{x}}_{n} ( {\overline{x}}_{k} - {\overline{x}}_{n} ) & ( 30 ) \\ ( b ) & \\ {A}_{XX} = k ( {x}_{n} - \frac{1}{n} {\sum }_{i = 1}^{n} ( i - 1 ) {sdx}_{i} ) ( ( {x}_{k} - {x}_{n} ) - \frac{1}{k} {\sum }_{i = 1}^{k} ( i - 1 ) {sdx}_{i} + \frac{1}{n} {\sum }_{i = 1}^{n} ( i - 1 ) {sdx}_{i} ) & ( 31 )\end{matrix}$$

And the computation for Autocovariance Function at lag k is to divide the result of equation (28) by n.

There are three other computation methods for Cross-covariance function; the three methods are described below respectively.
1. computation of by CSP, as shown below:

$${nC}_{XY} ( k ) = {CSP}_{n} - {{[ ( {x}_{k + 1} - {x}_{1} ) ( {x}_{k + 2} - {x}_{2} ) … ( {x}_{n} - {x}_{n - k} ) ]}_{1 \times ( n - k )} [ \begin{matrix}( {y}_{k + 1} - {\overline{y}}_{n} ) \\ ( {y}_{k + 2} - {\overline{y}}_{n} ) \\ ⋮ \\ ( {y}_{n} - {\overline{y}}_{n} )\end{matrix} ]}_{( n - k ) \times 1} - {{[ ( {x}_{1} - {\overline{x}}_{n} ) … ( {x}_{k} - {\overline{x}}_{n} ) ]}_{1 \times k} [ \begin{matrix}( {y}_{1} - {\overline{y}}_{n} ) \\ ⋮ \\ ( {y}_{k} - {\overline{y}}_{n} )\end{matrix} ]}_{k \times 1} \qquad ( 32 )$$

Wherein, equation (32) is using CSP and k^{th} order difference for computation thereof.

2. computation of by successive difference vector of (n−1) elements, shown as:

$${nC}_{XY} ( k ) = {{[ ( {x}_{1} - {\overline{x}}_{n} ) ( {x}_{2} - {\overline{x}}_{n} ) … ( {x}_{n - k} - {\overline{x}}_{n} ) ]}_{1 \times ( n - k )} [ \begin{matrix}( {y}_{1} - {\overline{y}}_{n} ) \\ ( {y}_{2} - {\overline{y}}_{n} ) \\ ⋮ \\ ( {y}_{n - k} - {\overline{y}}_{n} )\end{matrix} ]}_{( n - k ) \times 1} + {{[ ( {x}_{1} - {\overline{x}}_{n} ) ( {x}_{2} - {\overline{x}}_{n} ) … ( {x}_{n - k} - {\overline{x}}_{n} ) ]}_{1 \times ( n - k )} [ \begin{matrix}( {y}_{k + 1} - {y}_{1} ) \\ ( {y}_{k + 2} - {y}_{2} ) \\ \begin{matrix}⋮ \\ ( {y}_{n} - {y}_{n + k} )\end{matrix}\end{matrix} ]}_{( n - k ) \times 1} \qquad ( 33 )$$

3. subtracting h^{th} order difference from (h−1)^{th} order difference; using the foregoing result instead of the k^{th} order successive difference of equation (17). That is, to write the successive difference as:

sdxᵢ=(xᵢ−xₕ)−(xᵢ₋₂−xₕ), h=1, 2, . . . , n.
And rewrite equation (19) as:

$${{d}_{1 \times n ( k )}^{T} = \underbrace{[ 0 … 0}_{k items} {sdx}_{1} ( {x}_{2} - {x}_{h} ) - ( {x}_{1} - {x}_{h} ) … ( {x}_{n} - {x}_{h} ) - ( {x}_{n - 1} - {x}_{h} ) ]}_{1 \times n} ,$$

In the same manner, the i^{th} element of e_{1×n}^{T} can be written as: sdyᵢ=(yᵢ−yₕ)−(yᵢ₋₂−yₕ), h=1, 2, . . . , n,
That is, e_{1×n}^{T} can be shown as:

e_{1×n}^{T}=[sdyᵢ(y₂−yₕ)−(y₁−yₕ) . . . (yₙ−yₕ)−(yₙ₋₁−yₕ)]_{1×n}.

When the foregoing three methods are of univariate, computation of Autocovariance function can be applied. The method disclosed by the present embodiment uses the successive difference as a basis in order to perform recursion and update the CCF computation method. ACF is the special case of univariate thereof; for computation of ACF, replace the bivariate of the foregoing method with univariate.

Further, the computation accuracy of the present embodiment uses the certified value of the univariate summary statistical dataset of Statistical Reference Datasets (StRD) of National Institutes of Standards and Technology (NIST). Please refer to the website: http://www.itl.nist.gov/div898/strd/ (2011/01/08) for further details.

According to Altman et al. (2004), the computation accuracy refers to the dissimilary between the exact value and the result, and is represented by distance therebetween. For the dissimilary result, Altman et al. (2004) used 10 as the lowest log relative error (LRE); wherein the LRE refers to the log of 10 of the absolute value of exact value minus the result and then divided by the exact value. The LRE value represents the significant digits length of decimal data computation accuracy. Altman et al. (2004) defines LRE as:

$$L R E = \{ \begin{matrix}- {log}_{10} \vert \frac{exact - output}{exact} \vert , & if exact \neq 0 \\ - {log}_{10} \vert output - exact \vert , & if exact = 0\end{matrix} \qquad ( 34 )$$

Wherein, exact refers to the exact value, and output refers to the computation result.

When the computation result equals to the exact value, the LRE is marked as “exact”. In the past, many researchers use LRE value to determine the computation accuracy of data analysis software. For example, Wampler (1980) estimating computation accuracy of least squared algorithm; Simon (1985) estimating computation accuracy of linear regression procedure of MINITAB; McCullough (1998, 1999) estimating computation accuracy of SAS, SPSS, and S-PLUS; McCullough and Wilson (1999, 2002, 2005) estimating computation accuracy of EXCEL; Altman et al. (2007) discussing computation accuracy of R and S-PLUS; and Keeling and Pavur (2007) estimating computation accuracy of nine software. The present embodiment also uses LRE value for computation accuracy experiment report.

Empirical Comparison Data

The present embodiment discloses a new algorithm that is recursive and capable of updating Autocovariance Function and Cross-covariance function. Besides solving the problem of prior art being unable to perform updating, the algorithm thereof is further of high accuracy. In empirical comparison, the present embodiment uses the benchmark of the univariate summary statistical dataset of Statistical Reference Datasets (StRD) of National Institutes of Standards and Technology (NIST). Please refer to the website: http://www.itl.nist.gov/div898/strd/ (2011/01/08) for further details.

StRD Data

StRD is a benchmark datasets of the Statistical Engineering and Mathematical and Computational Sciences Divisions of National Institutes of Standards and Technology. It is used for diagnosing computation accuracy of the five statistics calculations below: (a) univariate summary statistics; (b) Analysis of Variance (ANOVA); (c) linear regression; (d) Markov chain Monte Carlo and (e) nonlinear regression. Please refer to the website: http://www.itl.nist.gov/div898/strd/ (2011/01/08) for further details.

The univariate summary statistics dataset of the present embodiment is described hereinafter.

Univariate summary statistics dataset is consist of nine datasets, each dataset provides exact mean, standard deviation and lag-1 autocorrelation coefficient of 15 significant digits for certification of computation accuracy. Since the primary object of the present embodiment is to compute the computation accuracy of CCF and ACF, the present embodiment converts lag-1 autocorrelation coefficient of the 9 datasets into ACF; the certified value thereof is shown in Table 1.

TABLE 1
Certified value of the univariate summary statistics of StRD

| Name of | Number of | |
|---|---|---|
| datasets | datasets | Certified value of ACF |
| PiDidits | 5000 | −0.0291891222080000 |
| Lottery | 218 | −10244.1567496751 |
| Lew | 200 | −23517.5956461250 |
| Mavro | 50 | 0.000000169273280000000 |
| Michelso | 100 | 0.003307662400000 |
| NumAcc1 | 3 | −0.333333333333333 |
| NumAcc2 | 1001 | −0.009980019801980 |
| NumAcc3 | 1001 | −0.009980019801980 |
| NumAcc4 | 1001 | −0.009980019801980 |

Comparison of Computation Accuracy

The present embodiment is performed under the Visual Studio .NET2003 of Windows XP. Further, it is using C++ under hardware resource of Intel Pentium M processor 1.73 GHz and 2G RAM. Wherein, the performed computation program is shown in Appendix 1.

In the comparison of computation accuracy, the present embodiment uses the LRE value in Altman et al. (2004). The LRE value represents the significant digits length of data computation accuracy. The present embodiment performs the program computation in Appendix 1 and converts the result into LRE value, and then round-off the 10 digit to 1 decimal place. If the output of 15 significant digits is the same as the certified value provided by StRD, which means the result is of the accuracy of 15 significant digits, it is marked as “Exact”. In the comparison of computation accuracy, the comparison of the present embodiment and the commonly used data analyzing software: PROC ARIMA of SAS ver. 9.0 is described in Table 2.

TABLE 2
LRE value comparison table of univariate summary
statistics datasets and ACF of SAS ver. 9.0

| Name of | | | This invention |
|---|---|---|---|
| data set | SAS | This invention | (round) |
| PiDidits | Exact | Exact | Exact |
| Lottery | Exact | Exact | Exact |
| Lew | Exact | Exact | Exact |
| Mavro | 12.8 | 12.8 | 14.2 |
| Michelso | 13.2 | 13.6 | 13.6 |
| NumAcc1 | Not | Exact | Exact |
| | provided | | |
| NumAcc2 | 7.7 | 7.7 | 7.7 |
| NumAcc3 | 7.7 | 7.7 | 7.7 |
| NumAcc4 | 7.5 | 7.5 | 7.7 |

Besides the computation method, the present embodiment further discloses a method comprising round-off function provided by software for increasing computation accuracy; which is also based on successive difference. In successive difference value, from estimating digits, used round-off method to reduce the error in computing the mean and Cross-covariance function. The C++ example of the present embodiment is:

sdx=Math::Round (x−x_{—}1,4).

The using of round-off function in steps in successive difference is also capable of increasing computation accuracy for the computation result. The column 4 of the Table 2 shows the computation result of successive difference computation using round-off function.

As shown in the column 2 and 3 of Table 2, the computation method of the present embodiment is of better performance on LRE value computation of the Michelso dataset than that of the SAS ver. 9.0. It requires at least 6 data for SAS ver. 9.0 to run and therefore SAS ver. 9.0 is not capable of running NumAcc1 dataset; however, the computation method of the present embodiment is not only without the limit, but also capable of obtaining exact result. Besides, when using round-off function in successive difference computation, it is further capable of increasing LRE value of Mavro and NumAcc4 datasets more than that of SAS ver. 9.0.

APPENDIX 1
Program of the present embodiment

```
#include “stdafx.h”
#using <mscorlib.dll>
using namespace System;
#include <stdio.h>
#include <float.h>
#include <Math.h>
#define n 1000
#define k 1
/******************************************************
****************************/
/************** The program is performing
autocorrelation function computation
**************************/
/************** Date: 2010/05/01
**************************/
/************** Authors: The Inventors
**************************/
/******************************************************
****************************/
int
main(void)
  {
    FILE *in_file;
    FILE *out_file;
    double sdx=0.0, sum_sdx=0.0, nsum_sdx=0.0,
dwd = 0.0, dgd = 0.0, css = 0.0;
    double n_cxx_k=0.0, dwd_k=0.0, dgd_k=
0.0, n_w_sum_sdx = 0.0, k_w_sum_sdy = 0.0,
            lagk_sdx = 0.0, isum_sdx = 0.0, utocov_k =
0.0, autocorr_k = 0.0, nsum_sdy = 0.0, n_w_sum_sdy=0.0;
    double x, x_1=0.0, lag[k], a=0.0, b=0.0;
    int i, index;
/*.....................................................
..............................................*/
        in_file = fopen (“numacc4.txt”,“r”);
      out_file = fopen (“out_auto_numacc4_NR.txt”,“w”);
      for (i=0; i<= n; i++)
        {
        fscanf(in_file, “%lf”, &x);
/* input data */
            index = i%k; /*
  compute for the remainder of the index i and k*/
              sdx = x − x_1; /*
compute the input successive difference */
        nsum_sdx = nsum_sdx + sdx; /* compute for the
  total weighted successive difference of n data */
        n_w_sum_sdx = n_w_sum_sdx + nsum_sdx;
                if (i>0)
                {
                  nsum_sdy = nsum_sdy + sdx; /* compute
for the total weighted successive difference of n data*/
                  n_w_sum_sdy = n_w_sum_sdy + nsum_sdy;
/* compute for the mean of n data */
                }
            if (i < k)
                  {
                      lagk_sdx = 0; /* let the
successive difference of lag-k be 0 */
                k_w_sum_sdy = n_w_sum_sdy;
                }
              else
                {
                lagk_sdx = lag[index]; /*
define the value of lag k */
                }
            lag[index] = sdx; /* put the
successive difference on a temporary array */
/******************************************************
*******************************/
/***** in the next two lines, compute for the
dwd_k of lagk *******/
            dgd_k = dgd_k + isum_sdx*sdx +
sum_sdx*lagk_sdx + i*sdx*lagk_sdx;
            dwd_k = dwd_k + dgd_k;
/******************************************************
****************************/
/***** do a n times iterative computation of CSS
in the next two lines ******/
                dgd = dgd + 2*sum_sdx*sdx + i*sdx*sdx;
                dwd = dwd + dgd;
/******************************************************
*************************/
/***** in the next two lines, do a separate
iterative computationfor dgd_l and dgd ******/
              isum_sdx = isum_sdx + i*lagk_sdx;
                sum_sdx = sum_sdx + i*sdx;
/******************************************************
**************************/
/**************** compute for the n times of lag-k
autocovariance function, the compute for n_cxx_k
**********/
                a = dwd_k/(i+1);
                b = k*(k_w_sum_sdy/k −
n_w_sum_sdy/(i+1))*n_w_sum_sdx/(i+1);
        n_cxx_k = dwd_k/(i+1) + k*(k_w_sum_sdy/k
− n_w_sum_sdy/(i+1))*n_w_sum_sdx/(i+1);
              autocov_k = n_cxx_k/(i+1);
                css = dwd/(i+1); /** compute
for the autocovariance function ***/
fprintf (out_file, “i=%d dwd_k=%.15le n_cxx_k=%.15e
css=%.15e a=%.15e b=%.15e autocov_k=%.15e \n”, i, dwd_k,
n_cxx_k, css, a, b, autocov_k);
/******************************************************
***********************/
/*************** compute for the lag-k autocorrelation
coefficient *****/
              autocorr_k =autocov_k / css;
/******************************************************
*******************/
        x_1=x; /** compute for
the iterated variable of n data **/
          }
                system(“PAUSE”);
}
```

What is claimed is:

1. A method for improving computation speed of cross-covariance function and autocovariance function for computer hardware, comprising steps of:
(1) calculating value of lag-k weighted successive difference by firstly multiplying successive difference value of two variables and a corresponding weighted coefficient, and then computing from first value in order; summing up the computation result until data input is ended, wherein the foregoing weighted coefficient is:
$$( n + 1 ) ( i + j - 1 ) - ij - \frac{n}{2} ( i + j + \vert i - j \vert ) ,$$
wherein i, j are index and n is data size;
(2) calculating an adjust term, wherein difference of mean of k^{th} data and mean of n^{th} data multiplying with k and then multiplying with mean of n^{th} data;
(3) dividing sum of the lag-k weighted successive difference and the adjust term of the mean deviation by n, the data size, for obtaining the Cross-Covariance function.

2. The method for improving computation speed of cross-covariance function and autocovariance function for computer hardware as defined in claim 1, wherein the computation method further comprises an n+1^{th} lag-k weighted successive difference value of a data; the value is capable of using product of successive difference values of two variables and corresponding weighted coefficient gᵢⱼ thereof, shown as gᵢⱼsdxᵢ*sdyⱼ; computing from first value to the n+1^{th} value, sum of the result is
$${\sum }_{i = 1}^{n + 1} {\sum }_{j = 1}^{n + 1} {g}_{ij} {sdx}_{i} {sdy}_{j} ,$$
and n times of the lag-k weighted successive difference value with n data is added thereto, obtaining (n+1) times of the n+1^{th} lag-k weighted successive difference value, and computation method for the weighted coefficient is:
gᵢⱼ=½(i+j−|i−j|−2), wherein i, j are index and n is the number of data input.

3. The method for improving computation speed of cross-covariance function and autocovariance function for computer hardware as defined in claim 1, wherein the step of calculating the adjust term is: multiplying the successive difference value and weighted coefficient lᵢ=(i−1), and subtract the result from n^{th} data; the computation is shown as:
$${\overline{x}}_{n} = {x}_{n} - \frac{1}{n} {\sum }_{i = 1}^{n} ( i - 1 ) {sdx}_{i} .$$

4. The method for improving computation speed of cross-covariance function and autocovariance function for computer hardware as defined in claim 1, wherein in successive difference value, from estimating digits, round-off method can be applied to each computation of the method to reduce computation errors of the mean and the Cross-covariance function.
